(19) United States
(12) Patent Application Publication
(10) Pub. No.: US 2023/0123836 A1
(43) Pub. Date: Apr. 20, 2023

(54) METHOD OF QUICK SLICING OF INGOT COLUMN

(71) Applicant: National Central University, Taoyuan City (TW)

(72) Inventors: Chih-Kuang Lin, Taoyuan City (TW); Jeng-Rong Ho, Taoyuan City (TW); Pi-Cheng Tung, Taoyuan City (TW)

(73) Assignee: National Central University, Taoyuan City (TW)

(21) Appl. No.: 17/548,610

(22) Filed: Dec. 13, 2021

(30) Foreign Application Priority Data
Oct. 20, 2021 (TW) 110138833

(51) Int. Cl. B23K 26/38; B23K 26/046; B23K 26/08; B23K 26/122

(52) U.S. Cl. CPC B23K 26/38; B23K 26/046; B23K 26/0823; B23K 26/122; B23K 26/0604

(57) ABSTRACT

A method for slicing an ingot column is provided, including the following steps: immersing the column into a solution; rotating the column; focusing the rotating column with a focusing device; and using a laser device to cut the rotating column into sliced wafers. The slicing equipment of the present invention has a simple structure, easy operation, small kerf of the column, and fast slicing speed.

### CROSS-REFERENCES TO RELATED APPLICATION

This application claims the benefit of priority from Taiwan Application Ser. No. 110138833 filed on Oct. 20, 2021.

### FIELD OF THE INVENTION

The present invention relates to a method for slicing an ingot column, particularly, a method that can reduce fragment generation, slice high-quality sliced wafers, and increase the processing speed. The design of immersing the ingot column in a solution for rotation and the Z-axis focusing technique hasthe effects of rapid processing and chip removal, improving the slicing efficiency and reducing the cost, wherein the solution can be an acidic, neutral, alkaline, or volatile liquid. The temperature of the solution can be higher than room temperature, room temperature, or lower than room temperature.

### BACKGROUND OF THE INVENTION

Generally, the conventional semiconductor ingot slicing process utilizes a diamond knife, or a wire saw to slice. However, as the final component product becomes smaller and smaller and the function becomes more advanced, the current slicing technology is bound to become more and more difficult. For example, when silicon carbide (SiC) is used as a compound semiconductor substrate material, the ingot growth, the processing, the component manufacturing method, and the required equipment are different from those of the current silicon-based semiconductors. In addition, due to the hard and brittle characteristics, material loss and processing time are increased when the conventional processing method is used, causing the challenge in processing even more difficult.

Currently, the existing ingot column slicing technology, such as diamond wire slicing, has a more significant problem of slow processing speed, high surface roughness, long processing time, and relatively high ingot column material loss because of the rigidity of ingot column (for example, SiC). In addition, the slicing technology that uses wire electrical discharge machining to slice the ingot column is a contact-free slicing process. Still, it is time-consuming and has the problem of wire breakage and wire vibration.

Different from the conventional diamond knife, wire saw slicing, or wire electrical discharge machining ingot column method, the ingot column laser cutting methods are proposed by quite a few patents. For example, the invisible laser cutting method adopted by the Japanese DISCO Corporation is a method having a complicated manufacturing process that requires detection of ingot lattice orientation of the ingot column first, and then a performance of laser cutting along a specific ingot lattice orientation, plus a peeling mechanism for separation to achieve the slicing effect. When the ingot column is cut by direct laser to achieve a high aspect ratio cutting, a disadvantage of not easy to discharge chips ensues. To solve the conventional technical problems, the inventors have been working hard to develop and create the slicing method of the present invention.

### SUMMARY OF THE INVENTION

The primary purpose of the present invention is to provide a method for slicing an ingot column, which includes the following steps: immersing an ingot column in a solution; rotating the ingot column; and focusing the rotating ingot column with a focusing device and using a laser device to cut the ingot column into sliced wafers.

### BRIEF DESCRIPTION OF THE DRAWINGS

FIG. 1 is a schematic diagram of an ingot column slicing device of the present invention.

FIG. 2 is a schematic diagram of an ingot column slicing device with a wafer receiving device of the present invention.

FIG. 3 is a schematic diagram of one embodiment of the ingot column slicing device of the present invention.

### DETAILED DESCRIPTION OF THE INVENTION

The primary purpose of the present invention is to provide a method for slicing an ingot column, which includes the following steps:
immersing an ingot column in a solution;
rotating the ingot column; and
focusing the rotating ingot column with a focusing device and using a laser device to cut the ingot column into sliced wafers.

The method for slicing an ingot column of the present invention can reduce fragment generation by using a laser device, the quality of the sliced wafers is higher, and the processing speed is increased. In addition, the design of immersing the ingot column in a solution for rotation and the Z-axis focusing technique has the effects of rapid processing and chip removal, improving the slicing efficiency and reducing the cost.

According to the method for slicing an ingot column of the present invention, wherein the solution can be an acidic, neutral, alkaline, or volatile liquid. The acidic solution can be sulfuric acid, phosphoric acid, nitric acid, hydrofluoric acid, or a combination thereof; the alkaline solution can be sodium hydroxide, potassium hydroxide, or a combination thereof; the neutral solution can be deionized water or pure water; and the volatile liquid can be isopropanol, ethanol, or a combination thereof. The solution can also be an oily liquid. When the solution is acidic or alkaline, the temperature range of the solution can be controlled to a high temperature state to increase the etching effect, and the temperature range can be between 80° C. and 800° C. When the solution is a neutral solution, the temperature of the solution can be controlled to a low temperature state, and the laser slicing effect can be increased by a larger temperature gradient. The temperature can be lower than 10° C., and preferably the temperature is freezing point.

According to the method for slicing an ingot column of the present invention, the material of the ingot column can be silicon (Si), silicon carbide (SiC), aluminum nitride (AlN), gallium oxide (Ga₂O₃), sapphire (Al₂O₃), cadmium sulfide (CdS), gallium nitride (GaN) or artificial diamond.

According to the method for slicing an ingot column of the present invention, the Z-axis focusing device is preferably a focusing device having a vertically movable mechanism or an optically movable focusing device. The vertically movable device can be a linear motor slide rail platform or a linear lead screw platform. The optical focusing device includes a vertically movable optical lens or zoom lens, capable of achieving the effect of synchronous processing and focusing.

According to the method of slicing an ingot column of the present invention, the laser device can be a single or a plurality of laser sources, and the laser source can be a point laser source or a line laser source. The ingot column can be subjected to simultaneous cutting and scanning by a plurality of point laser sources, or the ingot column can be subjected to simultaneous cutting of a plurality of sliced wafers by a plurality of line laser sources. The laser source can be a continuous or pulsed laser. The continuous laser can be a CO₂ laser, a CO laser, a helium-cadmium laser, a semiconductor laser, an optical fiber laser, or a helium-neon laser. The pulsed laser can be an excimer laser, an optical fiber laser, or a solid-state (YAG) laser. The wavelength of the laser light can be deep ultraviolet (EUV, DUV), ultraviolet (UV), green light, near-infrared light, mid-infrared light, or a combination thereof.

According to the method for slicing an ingot column of the present invention, the rotation speed of the ingot column is 0.1-20 RPM, preferably 1-7 RPM.

According to the method for slicing an ingot column of the present invention, it is primarily characterized in that: 1. using a laser ablation technology for slicing, in conjunction with a solution, preferably an etching solution capable of accelerating the slicing speed; 2. a Z-Axis focusing technology; 3. an ingot column rotation; 4. simultaneously subjecting the surface to modification during the laser slicing process to facilitate subsequent grinding and polishing processes. Quick slicing and chip removal can be achieved through the above characteristics, thereby achieving better slicing quality.

### DESCRIPTION OF EMBODIMENTS

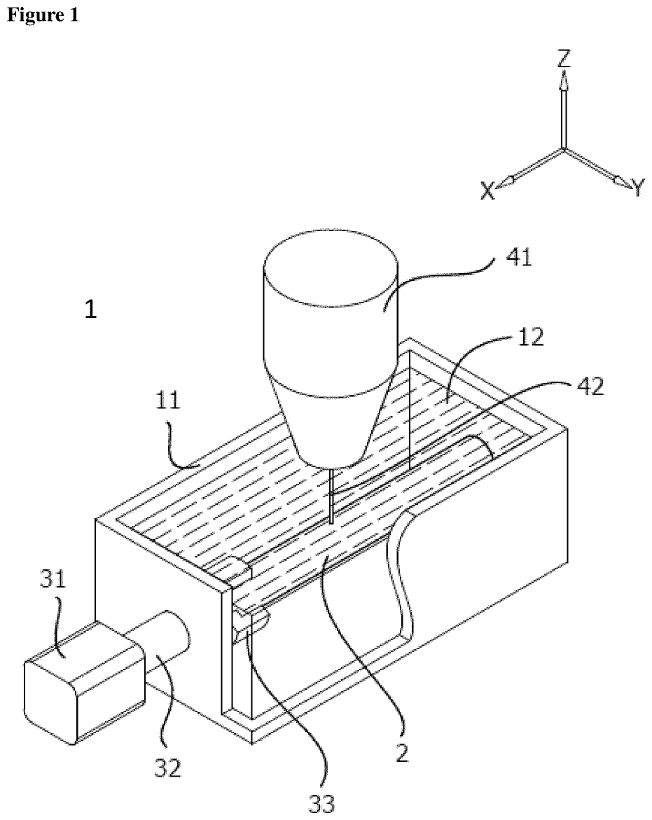

Please refer to FIG. 1, which is a schematic diagram of an ingot column slicing device 1 of the first embodiment of the present invention. The ingot column slicing device 1 included: a solution tank 11 for holding a solution 12; a motor 31; through a shaft 32 of the motor 31 a chuck 33 was driven to rotate, the chuck 33 clamped the ingot column 2 to rotate synchronously, and the motor 31 rotated with the X-axis as the central axis; a laser device 41 emitted a laser light 42 in the Z-axis direction onto the rotating ingot column 2 to slice the ingot column 2 into wafers. In addition, a set of three-dimensional moving mechanisms (a conventional mechanism, not shown) could drive the laser device or the laser source to move relative to the solution tank. For example, when the solution tank 11 was placed on a movable XYZ platform, it could move in the XYZ direction. The laser device could also be arranged on an XYZ gantry structure. The three-dimensional moving mechanism could be driven by a ball screw or a linear motor.

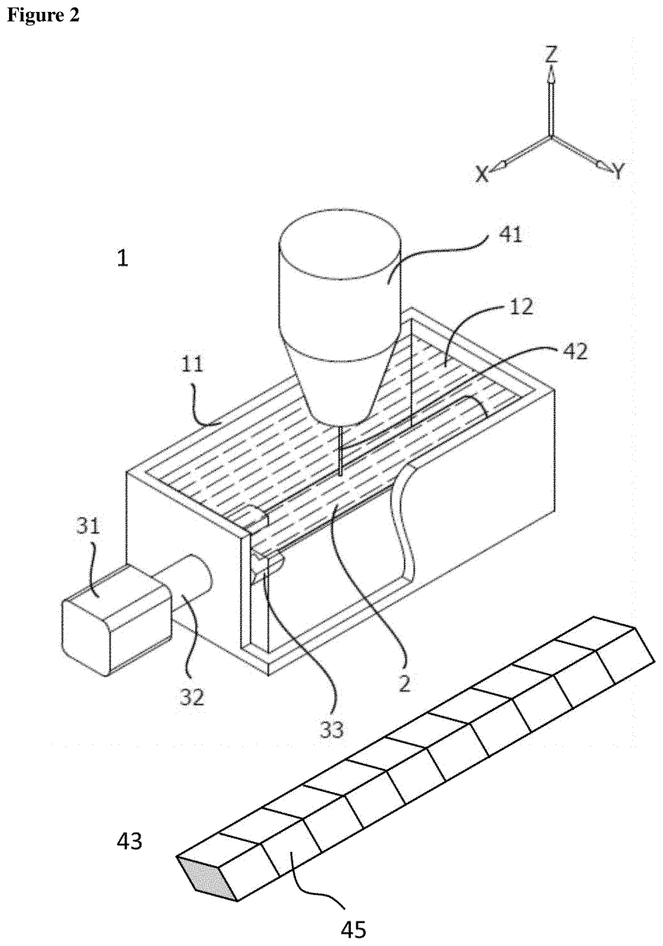

Please refer to FIG. 2, which is a schematic diagram of an ingot column slicing device 1 having a wafer receiving device 43 according to the first embodiment of the present invention. The wafer receiving device 43 was movable and placed beneath the sliced ingot column; the wafer receiving device was provided with a plurality of receiving cassettes 45, each receiving cassette could be moved to correspond to each slicing position. When a wafer was detached from the ingot column, it could be received by a receiving cassette underneath the wafer.

Please refer to FIG. 1, which discloses a method for slicing an ingot column of the present invention, including the following steps:

immersing an ingot column 2 in a solution 12, wherein the solution 12 was contained in a solution tank 11;

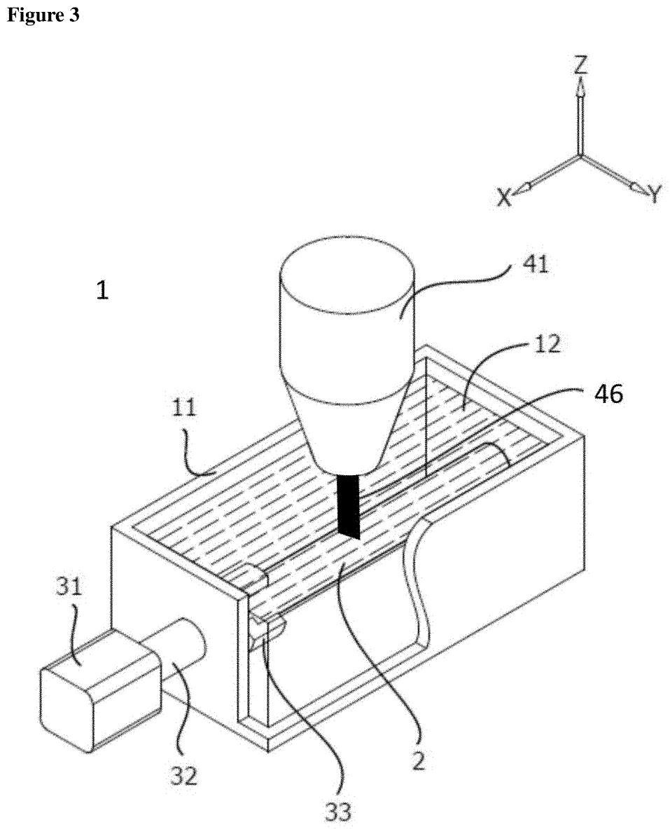

driving a chuck 33 to rotate through a shaft 32 of a motor 31, wherein the chuck 33 clamped the ingot column 2 to rotate synchronously, the rotational speed of the rotating device could be adjusted during a slicing process, and the axial direction of the rotation axis of the ingot column 2 was X-axis direction; and focusing the rotating ingot column 2 with a single or a plurality of laser lights 42 emitted from a single or a plurality of laser devices 41 or converting a point laser source into a line laser source 46 (see FIG. 3) by using a focusing device (not shown) to continually focus so as to slice the ingot column 2 into wafers. When the laser source was a point laser source, a galvanometer could be used to scan and cut the rotating ingot column.

In the method for slicing an ingot column of the present invention, the solution could be an acidic, neutral, alkaline, or volatile liquid. The acidic solution could be sulfuric acid, phosphoric acid, nitric acid, hydrofluoric acid, or a combination thereof; the alkaline solution could be sodium hydroxide, potassium hydroxide, or a combination thereof; the neutral solution could be deionized water or pure water; and the volatile liquid could be isopropanol, ethanol, or a combination thereof. The solution could also be an oily liquid. When the solution is acidic or alkaline, the temperature range of the solution can be controlled to a high temperature state to increase the etching effect, and the temperature range can be between 80° C. and 800° C. When the solution is a neutral solution, the temperature of the solution can be controlled to a low temperature state, and the laser slicing effect can be increased by a larger temperature gradient. The temperature can be lower than 10° C., and preferably the temperature is freezing point.

A nozzle could be arranged in the vicinity where the laser light 42 irradiated the ingot column 2, and molten slags generated by the slicing could be washed with the solution ejected from the nozzle. The solution 12 of the present invention could be pumped from the solution tank 11 with a pump, then flew through a filter to filter out the molten slags, and then returned to the solution tank 11.

The Z-axis focusing device was a vertically movable mechanical focusing device or an optically movable focusing device. The vertically movable mechanical device could be a vertically movable mechanism composed of a linear motor slide rail platform or a linear lead screw platform. The optically movable focusing device included a vertically movable optical lens or zoom lens. The vertically movable mechanical focusing device could be a vertically movable mechanism of laser head or a vertically movable mechanism of solution tank 11. The vertically movable mechanism achieved the effect of precision focusing through the movement along the Z-axis direction and precision positioning by a controller and a precision sensor.

The laser device of the present invention could be a single or a plurality of laser sources, and the laser source could be a point laser source or a line laser source. The point laser source could form a laser beam, and the line laser source could form a planar laser light. The ingot column could be subjected to a simultaneous scanning and cutting of a plurality of sliced wafers by a plurality of point laser sources, or the ingot column could be subjected to a simultaneous cutting of a plurality of sliced wafers by a plurality of line laser sources.

The laser source could be a continuous or a pulsed laser. The continuous laser could be a CO₂ laser, a CO laser, a helium-cadmium laser, a semiconductor laser, an optical fiber laser, or a helium-neon laser. The pulsed laser could be an excimer laser, an optical fiber laser, or a solid-state (YAG) laser. The wavelength of the laser light could be deep ultraviolet (EUV, DUV), ultraviolet (UV), green light, near-infrared light, mid-infrared light, or a combination thereof.

In the above embodiment, the ingot column was rotatable. However, for an ingot column having a low aspect ratio, for example, a 4-inch ingot column, the problem of slag discharge did not arise. The second embodiment of the present invention required no rotation of the ingot column. All other slicing steps were the same as the above embodiments.

### Example 1

A 248 or 355-nanometer wavelength (ultraviolet) laser was used in Example 1; the ingot column was a 4-inch SiC column ingot; the solution was potassium hydroxide, and the rotational speed of the ingot column was 0.1-20 RPM. the preferred rotational speed was 1-7 RPM. The Example successfully cut out SiC wafers, and the quality of the wafers was extremely high.

Compared with the existing techniques, the ingot column slicing technique of the present invention had the following advantages: 1. the structure of the ingot column slicing device was simple, and its operation was easy; 2. the incision of the ingot column was small, and the slicing speed was quick; 3. the ingot column rotated; 4. the surface was simultaneously modified during the laser slicing process to facilitate the subsequent grinding and polishing processes.

The above description for the present invention is only illustrative, and not restrictive. Those of ordinary skill in the art will recognize that various changes, modifications, or the like can be made without departing from the spirit and scope defined by the claims, and all will fall within the scope of the claims of the present invention.

What is claimed is:

1. A method for slicing an ingot column, comprising the following steps:
immersing the ingot column into a solution;
rotating the column; and
using a laser device to cut the rotating column into sliced wafers while continually focusing the rotating column with a focusing device during the laser cutting process.

2. The method of slicing the ingot column of claim 1, wherein the solution is an acidic, a neutral, an alkaline, or a volatile liquid; the acidic solution is sulfuric acid, phosphoric acid, nitric acid, hydrofluoric acid or a combination thereof, the alkaline solution is sodium hydroxide, potassium hydroxide or a combination thereof, the neutral solution is deionized water or pure water, the volatile liquid is isopropanol, ethanol, or a combination thereof, and the solution is also an oily liquid.

3. The method of slicing the ingot column of claim 1, when the solution is acidic or alkaline, the temperature range of the solution is controlled between 80° C. and 800° C.; when the solution is a neutral solution, the temperature of the solution is controlled below 10° C.

4. The method of slicing the ingot column of claim 1, wherein the material of the ingot column is silicon (Si), silicon carbide (SiC), aluminum nitride (AlN), gallium oxide (Ga₂O₃), sapphire (Al₂O₃), cadmium sulfide (CdS), gallium nitride (GaN), or artificial diamond.

5. The method of slicing the ingot column of claim 1, wherein the focusing device is a vertically movable mechanical focusing device or an optically moving focusing device.

6. The method of slicing the ingot column of claim 1, wherein the laser device is a single or multiple point laser sources; the single or multiple point laser sources cut the ingot column directly or use a galvanometer to scan and cut; and the cutting is for a single piece or multiple pieces at the same time.

7. The method of slicing the ingot column of claim 1, wherein the laser device is a single or multiple line laser sources, and the single or multiple line laser sources cut the ingot column into a single piece or multiple pieces at the same time.

8. The method of slicing the ingot column of claim 1, wherein the laser source of the laser device is a continuous or pulsed laser; the continuous laser is a CO₂ laser, a CO laser, a helium-cadmium laser, a semiconductor laser, a fiber laser, or a helium-neon laser; the pulsed laser is an excimer laser, an optical fiber laser, or a solid-state (YAG) laser; and the wavelength of the laser light is deep ultraviolet (EUV, DUV), ultraviolet (UV), green light, near-infrared light, or mid-infrared light.

9. The method of slicing the ingot column of claim 1, wherein the rotation speed of the ingot column is between 0.1-20 RPM.

10. The method of slicing the ingot column of claim 1, wherein the rotation speed of the ingot column is between 1-7 RPM.

11. A method for slicing an ingot column, comprising the following steps:
immersing the ingot column into a solution; and
clamping and fixing the ingot column, using a laser device to slice the ingot column, and using a laser device to cut the rotating column into sliced wafers while continually focusing the ingot column with a focusing device during the laser cutting process, wherein the laser device is a single-line or multi-line laser source.

12. The method of slicing the ingot column of claim 11, wherein the solution is an acidic, a neutral, an alkaline, or a volatile liquid; the acidic solution is sulfuric acid, phosphoric acid, nitric acid, hydrofluoric acid or a combination thereof, the alkaline solution is sodium hydroxide, potassium hydroxide or a combination thereof, the neutral solution is deionized water or pure water, the volatile liquid is isopropanol, ethanol, or a combination thereof, and the solution is also an oily liquid.

13. The method of slicing the ingot column of claim 11, when the solution is acidic or alkaline, the temperature range of the solution is controlled between 80° C. and 800° C.; when the solution is a neutral solution, the temperature of the solution is controlled below 10° C.

14. The method of slicing the ingot column of claim 11, wherein the material of the ingot column is silicon (Si), silicon carbide (SiC), aluminum nitride (AlN), gallium oxide (Ga₂O₃), sapphire (Al₂O₃), cadmium sulfide (CdS), gallium nitride (GaN), or artificial diamond.

15. The method of slicing the ingot column of claim 11, wherein the focusing device is a vertically movable mechanical focusing device or an optically moving focusing device.

16. The method of slicing the ingot column of claim 11, wherein the laser source of the laser device is a continuous or pulsed laser; the continuous laser is a CO₂ laser, a CO laser, a helium-cadmium laser, a semiconductor laser, a fiber laser, or a helium-neon laser; the pulsed laser is an excimer laser, an optical fiber laser, or a solid-state (YAG) laser; and the wavelength of the laser light is deep ultraviolet (EUV, DUV), ultraviolet (UV), green light, near-infrared light, or mid-infrared light.
